(19) United States
(12) Patent Application Publication
(10) Pub. No.: US 2018/0115691 A1
(43) Pub. Date: Apr. 26, 2018

(54) ARCHITECTURE FOR AND CAMERA DEVOID OF VIEWFINDER

(71) Applicant: POGOTEC, INC., Roanoke, VA (US)

(72) Inventors: AMITAVA GUPTA, ROANOKE, VA (US); STEFAN BAUER, BERN (CH); JEAN- NOEL FEHR, NEUCHÂTEL (CH); WILLIAM KOKONASKI, BELFAIR, WA (US)

(73) Assignee: POGOTEC, INC., ROANOKE, VA (US)

(21) Appl. No.: 15/789,574

(22) Filed: Oct. 20, 2017

Related U.S. Application Data
(60) Provisional application No. 62/411,453, filed on Oct. 21, 2016.
(60) Provisional application No. 62/430,730, filed on Dec. 6, 2016.
(60) Provisional application No. 62/418,093, filed on Nov. 4, 2016.
(60) Provisional application No. 62/434,884, filed on Dec. 15, 2016.
(60) Provisional application No. 62/436,932, filed on Dec. 20, 2016.

(51) Int. Cl. H04N 5/225; H04N 5/907

(52) U.S. Cl. CPC H04N 5/2257; H04N 5/907; H04N 5/04; H04N 5/2252; H04N 5/2253

(57) ABSTRACT

Examples of system architectures for cameras are described herein. Described architectures may facilitate small form-factor cameras which may be devoid of a viewfinder. In some example architectures, external RAM may not be provided. In some example architectures, an image signal processing (ISP) chip and a separate processing unit (e.g., a microcontroller unit (MCU) may be provided. The MCU may have sufficient internal memory so that little or no external volatile memory or RAM is used, for example, for image data buffering.

### CROSS-REFERENCE TO RELATED APPLICATIONS

This application claims the benefit under 35 U.S.C. 119 of the earlier filing date of U.S. Provisional Application No. 62/411,453 entitled “Camera System Architecture for Low Power and Small Form Factor”, filed Oct. 21, 2016. The aforementioned provisional application is hereby incorporated by reference in its entirety, for any purpose.

This application claims the benefit under 35 U.S.C. 119 of the earlier filing date of U.S. Provisional Application No. 62/418,093 entitled “Camera System having Small Form Factor and Low Power Requirements”, filed Nov. 4, 2016. The aforementioned provisional application is hereby incorporated by reference in its entirety, for any purpose.

This application claims the benefit under 35 U.S.C. 119 of the earlier filing date of U.S. Provisional Application No. 62/430,730 entitled “Enhanced Camera System having Small Form Factor with Low Power Requirements”, filed Dec. 6, 2016. The aforementioned provisional application is hereby incorporated by reference in its entirety, for any purpose.

This application claims the benefit under 35 U.S.C. 119 of the earlier filing date of U.S. Provisional Application No. 62/434,884 entitled “Enhanced Small Form Factor Camera”, filed Dec. 15, 2016. The aforementioned provisional application is hereby incorporated by reference in its entirety, for any purpose.

This application claims the benefit under 35 U.S.C. 119 of the earlier filing date of U.S. Provisional Application No. 62/436,932 entitled “Wearable Camera System”, filed Dec. 20, 2016. The aforementioned provisional application is hereby incorporated by reference in its entirety, for any purpose.

### TECHNICAL FIELD

Examples described herein relate to camera systems. Examples of architectures for small form-factor cameras which may be devoid of a viewfinder are described.

### BACKGROUND

Most small wearable cameras, like the ones developed by GoPro, include a system on a chip electronics design where the image signal processor and microcontroller are integrated into a single system on chip solution. Such chips are often large in size (usually 15 mm×15 mm or larger), and require a significant amount of power to operate, as well as, additional external RAM (random access memory). Standard camera systems generally use MPU (microprocessor units) combining multiple functions such as Image Signal Processor [ISP], Central Processing Functions and Digital Logic, Image Optimization Algorithm, and other embedded firmware functions, and require external RAM for data processing. Such systems have, per design, a higher foot print, e.g., 16×16 mm, and more power consumption including the power required for additional external RAM.

### SUMMARY

Examples of camera systems are described herein. An example camera system may include an image sensor configured to generate raw image data, an image signal processor coupled to the image sensor and configured to compress the raw image data to provided compressed image data, flash memory, and a microcontroller unit coupled to the image signal processor and the flash memory, the microcontroller unit comprising firmware configured to receive the compressed image data and control the flash memory to store the compressed image data.

In some examples, the microcontroller unit is configured to provide write and read requests to the flash memory.

In some examples, the microcontroller unit is configured to implement direct memory access and includes internal RAM comprising at least one data buffer. In some examples, the internal RAM comprises at least two alternating data buffers.

In some examples, the image signal processor and the microcontroller unit are provided on separate chips.

In some examples, the camera system may include a Wi-Fi chip coupled to the microcontroller unit.

In some examples, the camera system may include a housing enclosing the image signal processor and the microcontroller unit.

In some examples, the image signal processor, the microcontroller unit, and the flash memory are arranged along a first direction such that a first dimension of the camera system along the first direction is longer than a second dimension of the camera system, the second dimension being along a second direction perpendicular to the first direction.

In some examples, during use, the camera system is attached to eyewear, and the first dimension of the camera system is parallel to a temple of the eyewear. In some examples, wherein the image signal processor and the microcontroller unit each measure less than 10 mm in the second direction.

In some examples, a volume of the camera system is less than 6,000 cubic millimeters.

In some examples, the camera system is devoid of a viewfinder.

Another example of a camera system may include an image sensor configured to generate raw image data, an image signal processor coupled to the image sensor and configured to receive the raw image data and process the raw image data into processed image data, and a microcontroller unit coupled to the image signal processor and configured to receive the processed image data, the microcontroller unit comprising an internal memory and further configured to buffer the processed image data using the internal memory.

In some examples, the microcontroller unit is configured to buffer the processed image data without using external RAM.

In some examples, the microcontroller unit is configured to stream the data to flash memory external to the microcontroller unit.

In some examples, the flash memory is partitioned into a first area having a file system, and a second area without a file system, and wherein the microcontroller unit is configured to write the processed image data into the second area of the flash memory for fast streaming speed (“virtual RAM”) and later copy the processed image data into the first area at a lower speed.

In some examples, a circular buffer is implemented in the second area of the flash memory.

In some examples, the microcontroller unit comprises firmware configured to implement direct memory access.

In some examples, the internal memory comprises alternating data buffers.

In some examples, the camera system includes a microphone configured to provide sound data, and wherein the microcontroller unit is coupled to the microphone and further configured to receive the sound data and package video files using the processed image data and the sound data.

In some examples, the microcontroller unit is configured to synchronize the processed image data with the sound data.

In some examples, the image signal processor and the microcontroller unit are provided on separate chips.

Another example camera system may include an image signal processor, a processing unit coupled to the image signal processor, and an external non-volatile memory, wherein the processing unit is configured to use the external non-volatile memory as random access memory when processing image data provided by the image signal processor, and wherein the processing unit is configured to preserve most of the external non-volatile memory for image file storage, wherein the image file storage is accessible by an external device.

In some examples, the image file storage is accessible by the external device using a wireless connection via WIFI or Bluetooth.

In some examples, the external device is configured to access the image file storage through a physical connection, such as a USB connection.

### BRIEF DESCRIPTION OF THE DRAWINGS

FIG. 1 depicts exploded views of a camera system arranged in accordance with examples described herein.

FIG. 2 is a schematic illustration of printed circuit boards and exploded views of printed circuit board assemblies arranged in accordance with examples described herein.

FIG. 3 is a schematic illustration of a camera system arranged in accordance with examples described herein.

FIG. 4 is a schematic illustration of firmware for a microcontroller unit arranged in accordance with examples described herein.

FIG. 5 is a schematic illustration of firmware for use in a microcontroller unit arranged in accordance with examples described herein.

FIG. 6 is a schematic illustration of a memory arranged in accordance with examples described herein.

FIG. 7 is a schematic illustration of a camera system arranged in accordance with examples described herein.

FIG. 8 is a schematic illustration of a camera system attached to eyewear arranged in accordance with examples described herein.

FIG. 9 is a schematic cutaway view of a camera system arranged in accordance with examples described herein.

### DETAILED DESCRIPTION

Certain details are set forth herein to provide an understanding of described embodiments of technology. However, other examples may be practiced without various of these particular details. In some instances, well-known camera components, eyewear components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented here.

Examples described herein include camera systems utilizing a design architecture that involves a splitting of functionalities using multiple low power electronic components working at high frequency.

Examples described herein may have an improved ability in some examples to produce a high-resolution camera system with a small form factor. This may involve selecting the right components with the correct dimensions for example. In certain embodiments, a CMOS camera with aperture greater than or equal to 1 mm but with a cross section of less than 7 mm were selected for use as an image sensor described herein. This was coupled with an ISP with 1080p30 processing capacity and a Micro-controller with image and audio combination capabilities, but only a minimum amount of internal RAM, perhaps no more than around 256 kByte and only around 1024 kByte of non-volatile memory. The External non-volatile memory of the camera system may have no integrated memory managing functions as these would be handled within the MCU.

Examples described herein may refer to an MCU, which term is generally intended to refer to any digital processing unit where significant functionality beyond the central processing functions are integrated into the chip. Additional functions may include but are not limited to memory (both volatile and non-volatile), analog to digital conversion, digital to analog conversion, and input output ports (I/O ports).

Further, while the term Flash Memory is used to describe external non-volatile memory, other types of non-volatile memory maybe used.

Examples described herein include architectures for camera systems. The image signal processing of the camera system may be performed on a separate chip (e.g. a separate substrate having integrated circuits) than the image packaging. The image packaging may be performed on a separate processor from the signal processing. For example, the image signal processing may be performed by an image signal processor provided on a first chip. The image packaging may be performed by a processing unit (e.g. a processor), such as a microcontroller unit (MCU), provided on a second chip. The separate processor may itself have sufficient memory as to not utilize external random access memory (RAM) to process and/or package image files. In some example camera system architectures, the memory control function may reside in the microcontroller unit and not a flash memory device. In some example camera system architectures, a video packaging function may be performed by the microcontroller unit and may be controlled and/or performed by the firmware of the MCU. Example camera systems described herein may be implemented as a wearable camera (e.g., may be attachable to eyewear, one or more temples of eyewear, goggles, hats, visors, jackets, necklaces, rings, and/or watches). Examples of camera systems described herein may be devoid of a viewfinder (e.g., may be a view-finder-less camera). Data of images and/or videos captured by camera systems described herein may be communicated to one or more other computing systems for storage, viewing, and/or editing of images and/or video. Examples of camera systems described herein may be implemented using cell phone or smart phone cameras.

Examples of camera systems described herein may include an electronic system architecture such that components of the system architecture (e.g., chips) may be arranged in order to provide an advantageous form factor (e.g., minimize and/or reduce an overall size of the camera system).

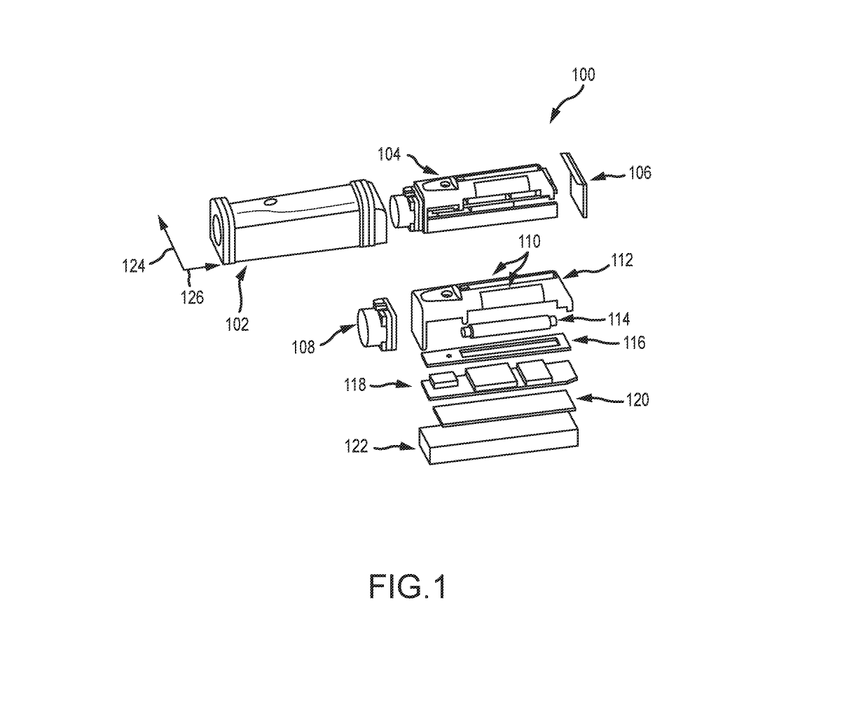

FIG. 1 depicts exploded views of a camera system arranged in accordance with examples described herein. The camera system 100 includes housing 102, sub assembly 104, and cover 106. A further exploded view of the sub assembly 104 is shown. The sub assembly 104 includes camera 108, interface(s) 110, sub-assembly 112, coil 114, microphone PCB 116, electronics PCB 118, adhesive 120, and battery 122. In other examples, additional, fewer, and/or different components may be used.

Camera systems described herein may include a housing. Housing 102 is shown as enclosing sub assembly 104. Generally any collection of components described as included in sub assembly 104 may be enclosed in housing 102. The housing 102 may be implemented, for example with an overmolded or other window positioned in front of camera 108. The housing 102 may be implemented, for example, using a plastic material having a wall thickness of 1 mm or less, 0.5 mm in some examples. The housing 102 may include one or more features to facilitate connection between the camera system 100 and an item worn by a user (e.g., eyewear, an eyewear temple, a wrist, watch, necklace, bracelet, goggles, hat, brim, jacket, shirt). For example, one or more channels may be provided on housing 102 which may receive and/or guide one or more fasteners (e.g., a rubber band) that may be used to attach camera system 100 to a worn item. In other examples, the housing 102 may include and/or may be coupled to one or more magnets or one or more ferromagnetic materials for facilitating a magnetic connection between the camera system 100 and a worn item.

The sub assembly 104 may in some examples be a molded interconnected device (MID).

The cover 106 may be connected to an end of the housing 102 and may partially enclose sub assembly 104. In some examples, cover 106 may include one or more openings for connection to the sub assembly 104 (e.g., one or more connectors, such as a USB, HDMI, headphone jack, or other connector). The cover 106 may in some examples be glued and/or welded to the housing 102.

Example camera systems described herein may include cameras. Camera 108 may be implemented, for example, using any of a variety of image sensors.

Camera systems described herein may include one or more interfaces. Interface(s) 110 are shown in FIG. 1. For example, one or more buttons may be provided which may control camera 108. For example, a button may be provided which may initiate image capture. A button may be provided which may initiate video capture. Generally, any of a variety of user interface(s) may be used to control camera system operation described herein, including, but not limited to, tactile, visual, and/or auditory interfaces. Accordingly, touches, images, and/or sounds (e.g., speech) may be used to control camera systems described herein.

Camera systems described herein may include one or more coils, such as coil 114. The coil 114 may be used to sense and/or receive power and/or data, and is optional in some examples. The coil 114 may be implemented using, for example, a wire-wrapped ferromagnetic (e.g., ferrite) core.

Accordingly, the camera system may provide for wireless data transfer in some examples using a Wi-Fi or other communication capability of electronics PCB 118 and may provide wireless power transfer using coil 114.

Two circuit boards may be provided in some examples—microphone PCB 116 and electronics PCB 118. The microphone PCB 116 may support a microphone while electronics PCB 118 may support integrated circuit chips that may provide image processing and/or image buffering.

Camera systems described herein may include one or more batteries, such as battery 122. The battery 122 may be a small battery in some examples, and may be recharged using a wired and/or wireless power interface. The battery 122 may be secured in sub assembly 104, for example using adhesive 120 to adhere the battery 122 to another component of the camera assembly, such as electronics PCB 118.

Arrangement of components of the camera system 100 may be selected to as to achieve a compact overall camera system. The camera 108 may be positioned at a front of the camera system 100, at a front of sub-assembly 112. Components on the electronics PCB 118 may be arranged so as to minimize an overall size and/or one or more dimensions of the electronics PCB 118. The coil 114 may advantageously fit into a cavity defined by microphone PCB 116 in some examples, which may aid in minimizing a dimension (e.g., a height) of the camera system. The microphone PCB 116 and electronics PCB 118 may be stacked within the housing 102. The stack of PCBs may be stacked on, and adhered to, battery 122.

Accordingly, an overall volume of camera systems described herein may be advantageously small in some examples. In some examples, a volume of less than 8000 mm³ may be achieved, in some examples less than 7000 mm³, in some examples, less than 6000 mm³, in some examples, less than 5000 mm³.

In some examples a width of the camera system 100 may be less than 15 mm, less than 14 mm in some examples, less than 13 mm in some examples, less than 12 mm in some examples, less than 11 mm in some examples, less than 10 mm in some examples, less than 9 mm in some examples, less than 8 mm in some examples.

In one example, dimensions of the camera system 100 may be a width of 9 mm (e.g., along direction 124), a length of 31.5 mm (e.g., along direction 126), and a height of 10.5 mm (e.g., along a direction perpendicular to direction 124 and direction 126).

In another example, dimensions of the camera system 100 may be a width of 8 mm (e.g., along direction 124), a length 31.5 mm (e.g., along direction 126), and a height of 9.5 mm (e.g., along a direction perpendicular to direction 124 and direction 126).

In another example, dimensions of the camera system 100 may be a width of 7.5 mm (e.g., along direction 124), a length of 31.5 mm (e.g., along direction 126), and a height of 7.5 mm (e.g., along a direction perpendicular to direction 124 and direction 126).

Note that the camera system 100 may be devoid of a viewfinder. Data corresponding to images and/or videos captured by the camera system 100 may be stored initially in a memory, for example on electronics PCB 118. The data may be transferred to one or more other computing systems for further processing and/or storage. One or more wired and/or wireless connections may be made to the camera system 100 for transfer of data.

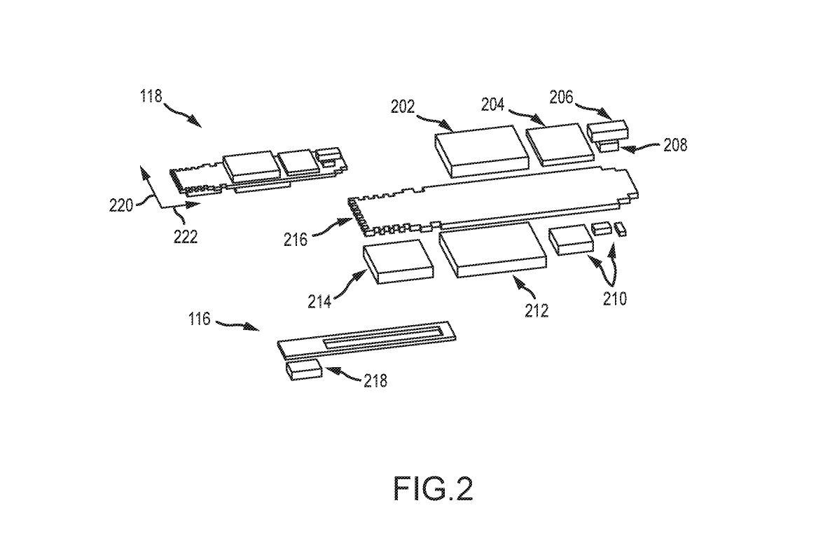

FIG. 2 is a schematic illustration of printed circuit boards and exploded views of printed circuit board assemblies arranged in accordance with examples described herein. FIG. 2 illustrates electronics PCB 118 and microphone PCB 116. The electronics PCB 118 may include Wi-Fi chip 202, microcontroller unit 204, antenna 206, oscillator 208, power management 210, memory 212, image signal processor 214, and pads 216. The microphone PCB 116 may include microphone 218. In other examples, additional, fewer, and/or different components may be used. The PCBs and assemblies shown in FIG. 2 may be used to implement and/or be implemented by camera systems described herein, such as camera system 100 of FIG. 1. In some embodiments, the microphone component on PCB 116 may be placed on the same PCB 118 as the other camera components.

The electronics PCB 118 may include a printed circuit board (e.g., a substrate, such as a ceramic substrate, which may include one or more interconnects). The printed circuit board may support (e.g., may have mounted to it) one or more integrated circuit chips. Connections between the integrated circuit chips and the printed circuit board may be made through a variety of interconnect techniques (e.g., bumps). The printed circuit board of electronics PCB 118 may support Wi-Fi chip 202, microcontroller unit 204, and antenna 206 on a first side of the printed circuit board. Image signal processor 214, memory 212, and power management 210 may be supported on a second side of the printed circuit board. Note that, in other examples, the components may be differently distributed among the sides of the printed circuit board. Note also that the components on opposite sides of the printed circuit board may be in electronic communication through the printed circuit board (e.g., through interconnects on the printed circuit board).

The electronics PCB 118 may include Wi-Fi chip 202. The Wi-Fi chip 202 may be optional and may be used to facilitate wireless communication with other computing systems. Examples of communication protocols which may be implemented by Wi-Fi chip 202 include, but are not limited to, any Wi-Fi standard and/or BLUETOOTH. The chip 202 is optional and may not be included in some examples. The Wi-Fi chip 202 may be a separate chip from the image signal processor 214 and microcontroller unit 204. Separating the Wi-Fi chip 202 may additionally facilitate minimizing a dimension of the overall camera system (e.g., a direction 220).

The antenna 206 may be coupled to Wi-Fi chip 202 and may be used to transmit and/or receive data from other computing systems described herein over a wireless network, such as an Internet, wide-area network (WAN), and/or local-area network (LAN). The oscillator 208 may be coupled to antenna 206 and may be utilized to generate one or more waveforms used in wireless communication. The antenna 206 and oscillator 208 are optional and may not be included in some examples.

Other communications interfaces may be implemented and may be included on electronics PCB 118, such as, but not limited to, one or more USB and/or HDMI interfaces.

Note that the microcontroller unit 204 and the image signal processor 214 may be provided on separate chips. In some examples, a length or width dimension of the microcontroller unit 204 and the image signal processor 214 may be less than a smallest length or width dimension of a chip which had incorporated both functionalities into a single system on chip. For example, a system on a chip may have a dimension of 15 mm×15 mm, while the microcontroller unit 204 and the image signal processor 214 may each have a dimension of less than 15 mm, less than 12 mm in some examples, less than 10 mm in some examples, less than 8 mm in some examples, less than 6 mm in some examples. Accordingly, the use of two chips may allow for a dimension of the camera system to be reduced. For example, the microcontroller unit 204 and image signal processor 214 may have a width dimension (e.g. along direction 220) which is less than 15 mm in some examples, less than 12 mm in some examples, less than 10 mm in some examples, less than 8 mm in some examples, less than 6 mm in some examples. The microcontroller unit 204 and image signal processor 214 may be arranged next to one another along direction 222, perpendicular to direction 220. In this manner, the overall camera system utilizing the PCB assemblies shown in FIG. 2 may have a width dimension (e.g., along direction 220) shorter than a length dimension (e.g., along direction 222). Similarly, a height dimension of the camera system (e.g., perpendicular to both direction 220 and direction 222) may be shorter than a length dimension of the camera assembly (e.g., along direction 222).

Memory 212 may be provided on a separate chip, and may be coupled to microcontroller unit 204 and/or image signal processor 214. The memory 212 may be implemented using, for example, flash memory (e.g., NAND and/or NOR flash memory). The memory 212 may be implemented, for example, using a flash integrated circuit and/or chip. In some examples, a largest dimension of a chip used to implement memory 212 may be less than 15 mm, less than 12 mm in some examples, less than 10 mm in some examples, less than 8 mm in some examples.

Power management 210 may include circuitry which may receive and/or condition power which may be used by other components of the camera system described herein. For example, power management 210 may include power harvesting circuitry, wireless power receiver circuitry, etc.

The pads 216 may provide for electrical connections between the components of the electronics PCB 118 and other components of the camera system.

Microphone PCB 116 is illustrated as supporting microphone 218. The microphone PCB 116 may be coupled to electronics PCB 118 to provide for signal transfer between the microphone 218 and other components of the camera system, such as microcontroller unit 204. In some examples, the microphone 218 may be supported instead by electronics PCB 118.

The microphone PCB 116 includes a cavity sized to fit a coil when assembled into the camera system, as generally illustrated in FIG. 1. The coil may be optional. In some examples microphone PCB 116 may not define a cavity.

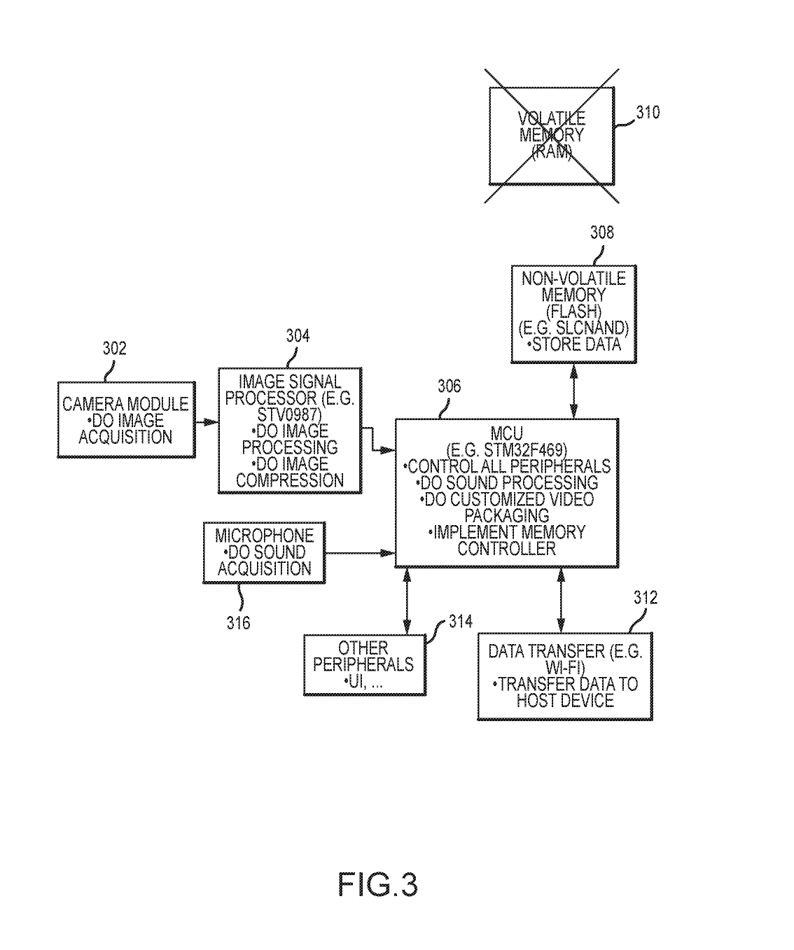

FIG. 3 is a schematic illustration of a camera system arranged in accordance with examples described herein. The camera system 300 includes image sensor 302, image signal processor 304, microcontroller unit 306, flash memory 308, Wi-Fi chip 312, peripheral(s) 314, and microphone 316. In some examples, external RAM 310 may not be used for processing of image and/or video as described herein. Accordingly, external RAM 310 may not be present in some examples. The image sensor 302 may be coupled to image signal processor 304. The image signal processor 304 may be coupled to microcontroller unit 306. The microphone 316 may be coupled to microcontroller unit 306. The microcontroller unit 306 may be coupled to flash memory 308, Wi-Fi chip 312, and peripheral(s) 314. Additional, fewer, and/or different components may be used in some examples.

The camera system 300 may be implemented by and/or used to implement camera systems described herein, such as camera system 100 of FIG. 1 and/or the printed circuit boards or assemblies of FIG. 2.

The image sensor 302 may be implemented using a variety of image sensors (e.g., a camera, a camera on a chip, a car). The image sensor may generally generate raw image data responsive to incident radiation (e.g., light). The raw image data may include, for example, pixel data, and may include pixel data for each pixel of the image sensor 302. In some examples, an Omni Vision OV8825 image sensor may be used to implement image sensor 302. The Omni Vision OV8825 may have dimensions of 8.6 mm×8.6 mm×5.38 mm and may provide 8 Mpixels of data at 1080p30. In some examples, a ST Microelectronics VS6955 chip may be used to implement image sensor 302. The VS6955 chip may have dimensions of 6.5 mm×6.5 mm×4.6 mm and may provide 5 Megapixels of raw data at 1080p30.

The image signal processor 304 (ISP) may be implemented using any of a variety of ISPs. The image signal processor 304 may be provided on a chip (e.g., a substrate, such as a silicon substrate) which is separate from a chip used to implement image sensor 302 and/or microcontroller unit 306. The image signal processor 304 may be coupled to image sensor 302. The image signal processor 304 may receive raw image data from the image sensor 302 and may compress the raw image data to provide compressed image data. In some examples, a GC6500 chip available from GeoSemi may be used to implement image signal processor 304. The GC6500 may have dimensions of 8 mm×10 mm×1 mm, and may provide 5 Megapixels of data at 30 fps (frames per second). In some examples, a ST Microelectronics STV0987 chip may be used to implement the image signal processor 304. The STV0987 may have dimensions of 5 mm×5 mm×1.1 mm.

The flash memory 308 may be implemented using generally any variety of flash memory. In some examples, another type (e.g., non-flash) of memory may be used to implement flash memory 308. The flash memory 308 may be coupled to microcontroller unit 306. In some examples, the flash memory 308 may be implemented using a Toshiba TCS88VG2SCHBA16 chip, which may have dimensions of 6.5 mm×8 mm×0.9 mm, and may implement serial NAND and may provide 4 Gbit of storage.

While named a “microcontroller unit”, the microcontroller unit 306 may be implemented using any of a variety of processor units (e.g., processors) which may perform the functions described herein with reference to microcontroller units. In some examples, a microcontroller unit (MCU) may be used. The additional processor, e.g., microcontroller unit 306, may be coupled to the image signal processor 304 and the flash memory 308. The microcontroller unit 306 may include firmware to perform functions described herein as performed by microcontroller unit 306. The microcontroller unit 306 may implement direct memory access to store compressed image data from the image signal processor 304. The microcontroller unit 306 may include internal memory to the microcontroller unit 306, and the microcontroller unit 306 may implement direct memory access to the internal memory. The microcontroller unit 306 may in some examples buffer processed image data from the image signal processor 304 using the internal memory of the MCU. The internal memory may include alternating data buffers, e.g., two alternating data buffers. Note that the microcontroller unit 306 may buffer the processed image data without using external RAM, e.g., without external RAM 310 in some examples. The microcontroller unit 306 may receive compressed image data from the image signal processor 304 and may control the flash memory 308 to store the compressed image data. In some examples, the microcontroller unit 306 may provide write and read requests to flash memory 308. In some examples, the microcontroller unit 306 may implement direct memory access. The microcontroller unit 306 may include internal RAM which may include at least one data buffer. In some examples, the internal RAM may include at least two alternating data buffers.

In some examples, during operation, image signal processor 304 may provide compressed image data to microcontroller unit 306. The microcontroller unit 306 may implement a digital camera interface to one or more butlers in internal RAM of the microcontroller unit 306 (e.g., two alternating buffers). The buffers in the internal RAM of the microcontroller unit 306 may be coupled to a flexible memory controller which may be implemented by the microcontroller unit 306 and may couple the microcontroller unit 306 to the flash memory 308.

In some examples, the microcontroller unit 306 may be implemented using a ST Microelectronics 32F756 chip, which may have dimensions of 4.5 mm×5.8 mm×0.6 mm. The clock speed of the microcontroller unit (306) may determine the rate of image processing. A higher clock speed generally enhances energy consumption, leading to a design requirement for a bigger battery in order to maintain the time between recharges to a manageable and acceptable (to the consumer) level. A clock speed of 168 MHZ was selected in some examples for the optimum function of the microcontroller unit, in accordance with the dimensional and power consumption constraints, the range being 150-300 MHZ in some examples.

The microcontroller unit 306 may control the image signal processor 304. For example, the microcontroller unit 306 may control the capture of one or more still images and/or image stream(s) (e.g., video). The microcontroller unit 306 may send image configuration data to the image signal processor 304 to configure the image signal processor 304 and/or image sensor 302. The microcontroller unit 306 may provide power and/or clock signals) to the image signal processor 304 and/or image sensor 302.

The microcontroller unit 306 may control the flash memory 308. For example, the microcontroller unit 306 may identify and organize the flash memory 308. The microcontroller unit 306 may provide write and/or read commands to the flash memory 308.

The microcontroller unit 306 may control external data communication. For example, the microcontroller unit 306 may detect external connected devices (e.g., one or more base stations, and/or other computing devices). The microcontroller unit 306 may coordinate data transfer between external connected devices and the camera system 300. The microcontroller unit 306 may provide data (e.g., image and/or video data) to one or more interfaces for transmission to the external device. The microcontroller unit 306 may exchange log and/or configuration data with one or more external devices.

The microcontroller unit 306 may control one or more user interfaces. For example, the microcontroller unit 306 may receive inputs from, and act responsive to, user interface elements (e.g., one or more buttons or other tactile, visual, or auditory input). The microcontroller unit 306 may provide one or more output signals—e.g., to control an indicator, such as an LED, display, or other visual, tactile, or auditory output.

The microcontroller unit 306 may control one or more microphones, such as microphone 316. The microcontroller unit 306 may provide or more configurations to the microphone 316. The microcontroller unit 306 may receive audio data from the microphone 316.

The microcontroller unit 306 may package video data. For example, the microcontroller unit 306 may package image stream data (e.g., received from the image signal processor 304) and audio data (e.g., received from microphone 316) into one or more containers.

The microcontroller unit 306 may control power management for the camera system 300. For example, the microcontroller unit 306 may enable and/or disable external devices which may consume power. The microcontroller unit 306 may enter and/or exit a power consumption mode responsive to one or more wake-up conditions.

In some examples, the microcontroller unit 306 may not control battery charging and/or discharging. In some examples, the microcontroller unit 306 may not have direct control of image sensor 302 (e.g., to perform color balancing and/or noise filtering). In some examples, the image signal processor 304 may provide color balancing and/or noise filtering. In some examples, the microcontroller unit 306 may not conduct Wi-Fi communication and/or control an Ethernet stack or antenna. Those functions may be performed by Wi-Fi chip 312 in some examples.

In some examples, the flash memory 308 may be partitioned into a first area having a file system, and a second area without a file system. The microcontroller unit 306 may write the processed image data into the second area of the flash memory (e.g., without a file system). The microcontroller unit 306 may implement the memory access to the second area of the flash memory 308 such that a file system may not be present in the second first area of the flash memory 308 and/or may not be used. The second area of the flash memory 308 may include a circular buffer.

The microphone 316 may provide data indicative of sound incident on the microphone 316. The microcontroller unit 306 may receive data from the microphone 316. The microcontroller unit 306 may package video files using the processed image data from the image signal processor 304 and the sound data from the microphone 316. The microcontroller unit 306 may synchronize the processed image data with the sound data. In some examples, the microphone 316 may be implemented using a ST Microelectronics MP34DB02 microphone, which may have dimensions of 4 mm×3mm×1 mm.

Accordingly, the microcontroller unit 306 may control memory functions of the camera system 300 (e.g., all memory functions in some examples), package video (e.g., all video files in some examples) of the camera system 300, and may use only internal RAM and/or flash to buffer image and/or video data.

The Wi-Fi chip 312 may provide data transfer from the camera system 300 to one or more other computing systems, such as a base unit or computer. The Wi-Fi chip 312 may receive data from the microcontroller unit 306, which data may be stored in flash memory 308. The Wi-Fi chip 312 may transmit data using generally any wireless communication protocol. In some examples, Wi-Fi chip 312 may be implemented using a TI CC3200 chip, which may have dimensions of 9 mm×9 mm×1 mm. In some examples, Wi-Fi chip 312 may be implemented using a Murata ZX chip, which may have dimensions of 7mm×6 mm×1.1 mm. In other examples, a wired interface may be implemented additionally or instead of Wi-Fi chip 312. For example, a USB, or other wired interface may be provided.

Accordingly, components used to implement camera systems described herein, such as image sensor 302, image signal processor 304, microcontroller unit 306, flash memory 308, Wi-Fi chip 312, microphone 316, or combinations thereof, may advantageously have sizes of less than 10 mm×10 mm in some examples, less than 8 mm×8 mm in some examples. In some examples the components may have smaller dimensions.

Camera systems described herein may include one or more peripherals, e.g., peripheral(s) 314. For example, one or more user interface elements may be provided, such as but not limited to, a button, or other tactile, visual, and/or auditory input. In some examples, one or more output elements may be provided, such as but not limited to, a light (e.g., an LED), a display, an alarm, a speaker, or other tactile, visual, and/or auditory output. Notwithstanding the inclusion of an output display in some examples, in some examples, the camera system 300 may be devoid of a viewfinder (e.g., the camera system 300 may not include any output which displays a current view of the camera or otherwise allows for the current view of the camera to be viewed by a user).

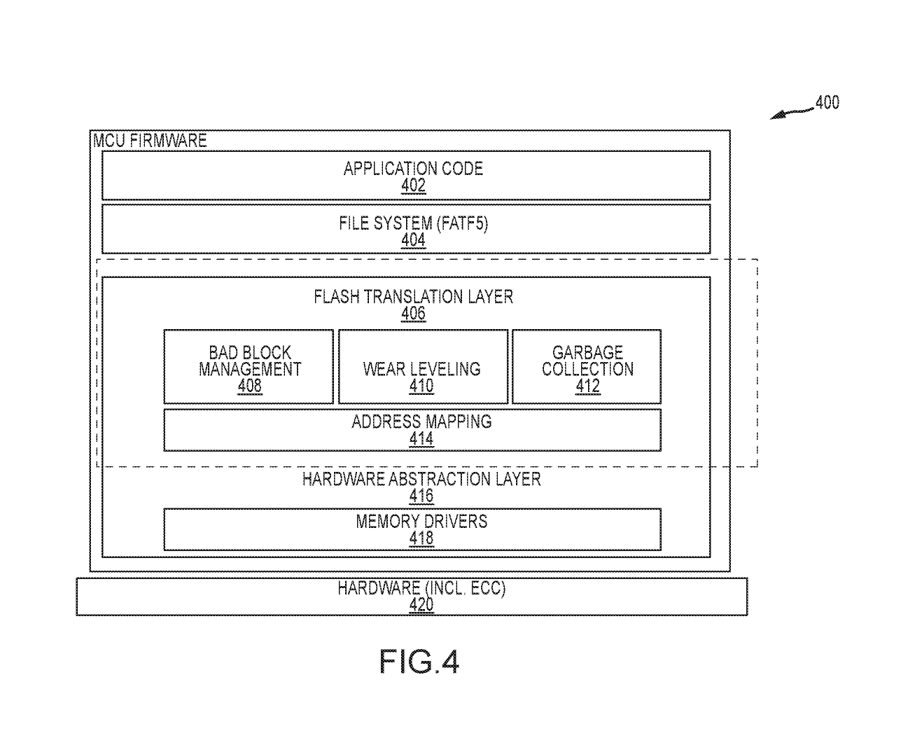

FIG. 4 is a schematic illustration of firmware for a microcontroller unit arranged in accordance with examples described herein. The microcontroller unit 400 may include firmware having application code 402, file system 404, and hardware abstraction layer 416. The firmware may operate in conjunction with hardware 420, The flash translation layer 406 may include bad block management 408, wear leveling 410, garbage collection 412, and address mapping 414. The hardware abstraction layer 416 may include one or more memory driver(s) 418.

The firmware shown in FIG. 4 may be implemented in any microcontroller unit described herein, such as microcontroller unit 204 of FIG. 2, and/or microcontroller unit 306 of FIG. 3.

Note that the flash translation layer 406 may be implemented by microcontroller units described herein. In contrast, the flash translation layer 406 may have been implemented inside one or more flash memory chips themselves in other systems. Accordingly, examples described herein may implement memory management inside a microcontroller unit, which may allow for the use of chip sizes which may be advantageous to a small form factor camera system.

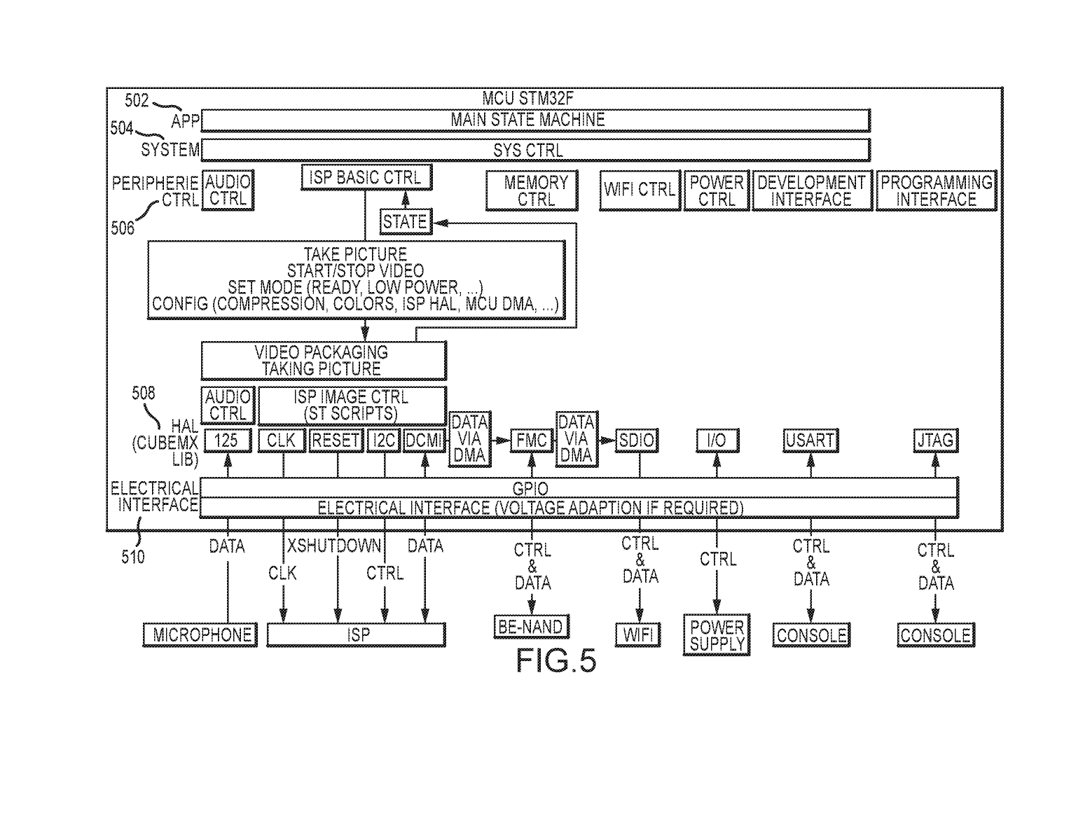

FIG. 5 is a schematic illustration of firmware for use in a microcontroller unit arranged in accordance with examples described herein.

The firmware shown in FIG. 5 may be implemented in any microcontroller unit described herein, such as microcontroller unit 204 of FIG. 2, and/or microcontroller unit 306 of FIG. 3, and may be combined with the firmware described and shown with reference to FIG. 4.

The firmware may include application layer 502, system layer 504, peripheral control layer 506, hardware abstraction layer 508, and one or more electrical interface(s) 510. Additional, fewer, and/or other layers may be used in other examples.

The application layer 502 may include a main state machine, which may implement one or more applications on the microcontroller unit. The system layer 504 may include system control functions. The peripheral control layer 506 may include firmware which may be used to control one or more other components. For example, depicted in FIG. 5 are audio control, image signal processor control, memory control, Wi-Fi control, power control, a development interface, and a programming interface. Any combination of these components may be present in the peripheral control layer 506 in various examples. The image signal processor control may include firmware for taking a picture, starting and/or stopping a video recording, setting a mode (e.g., ready, low power), and/or configuration (e.g., compression configuration, color configuration, direct memory access configuration, etc.). The peripheral control layer 506 may include video packaging firmware. The peripheral control layer 506 may include audio control.

The hardware abstraction layer 508 may include a variety of firmware blocks for controlling particular hardware or combinations of hardware. For example, shown in FIG. 5 are a control block of receiving data from a microphone. Hardware abstraction layer 508 may also include image signal processor control (e.g., ST scripts) which may, for example, provide a clock signal, reset (e.g., shutdown) signal, and/or control signal to an image signal processor. Moreover, the image signal processor control block may send data to, and receive data from, the image signal processor.

The hardware abstraction layer 508 may include a block for flash memory control. The flash memory control block may receive data from the image control bock (e.g., using direct memory access). The flash memory control back may receive data and control signals from, and/or provide data and control signals to, a flash memory (e.g., NAND device).

The hardware abstraction layer 508 may include a block for input/output control which may receive data from the flash memory control block (e.g., using direct memory access). The input/output control block may provide control and/or data signals to a Wi-Fi interface (e.g., a Wi-Fi chip) for transmission to one or more other devices. In other examples, other interface control blocks may be implemented.

The hardware abstraction layer 508 may include an input/output block for providing a control signal to a power supply.

The hardware abstraction layer 508 may implement other interfaces—e.g., USART and/or JTAG for providing control and/or data signals to and/or from a remote system (e.g., a console).

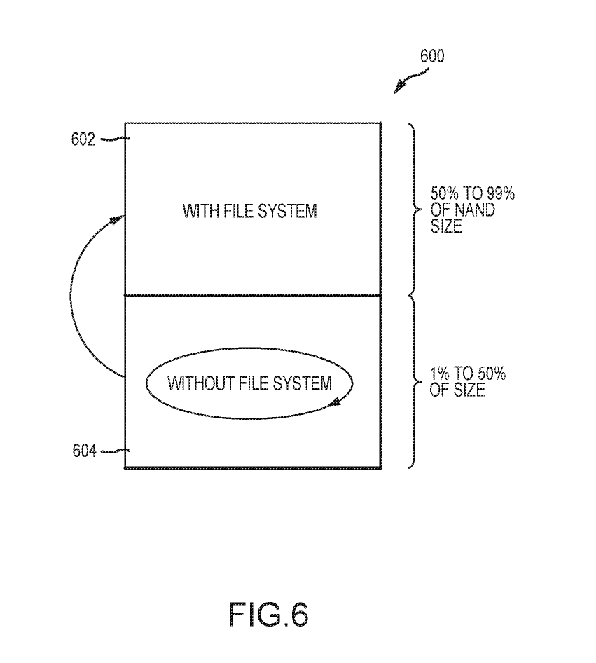

FIG. 6 is a schematic illustration of a memory arranged in accordance with examples described herein. The memory 600 may be used to implement and/or may be implemented by memory described herein, such as memory 212, and/or flash memory 308.

The memory 600 includes two areas of memory—e.g., partition 602 and partition 604. Additional or different areas may be included in other examples. The partition 602 may have a file system implemented in the partition 602. The partition 604 may not have a file system implemented in the partition 604. Accordingly, microcontroller units described herein (e.g., microcontroller unit 306 of FIG. 3) may implement direct memory access to the partition 604.

Generally, memory described herein, such as flash memory 308 of FIG. 3 may be partitioned such that a percentage (e.g. 1 to 50 percent in some examples) of the storage in memory is allocated specifically for image data buffering (e.g., virtual RAM). The partition allocated specifically for image data buffering (e.g., partition 604 of FIG. 6) may not have a file system. The partition 604 may accordingly not be accessible to other computing systems without direct memory access. Data may be able to be loaded into the partition 604 at a very high rate due, at least in part, to the lack of a file system.

A separate percentage or portion of the full memory storage (e.g., 50 to 99 percent of the memory in some examples) may be reserved for image file storage that may be accessible to other computing systems accessing the memory. In this manner, a single small form factor external memory chip (e.g., external to an MCU) can be used to serve dual function. A need for including additional external random access memory (RAM) in a camera system may be reduced and/or eliminated.

During operation, a processor of a camera system (e.g., microcontroller unit 306 of FIG. 3) may stream data to flash memory which is external to the processor (e.g., external to microcontroller unit 306). That streaming may be performed by streaming the data to the partition 604, which may allow for a higher speed of data transfer (e.g., a streaming speed). The data may later be copied, at a different speed, less than the streaming speed, to a partition with a file system (e.g., the partition 602). In the partition 602, the data may be accessible to one or more external devices using a wireless connection (e.g., Bluetooth) and/or a physical, wired connection (e.g., USB, HDMI). Once files are loaded into system layer 504, they may be transferred to partition 602 for retrieval by external devices if that is desired for certain data at certain times. The blocks of data in partition 604 which had been used as virtual RAM for transferred files may be deleted once the file is transferred to partition 602. Accordingly, a circular buffer may be implemented in partition 604 to provide wear leveling in sonic examples for sectors reserved for data buffeting (e.g., virtual RAM).

In some examples of video files, the partition 604 may not be used. For example, a video file using less than a threshold amount of data (e.g., 1 Mpixel for 720p HD), the video file may be written directly to partition 602 without use of the partition 604.

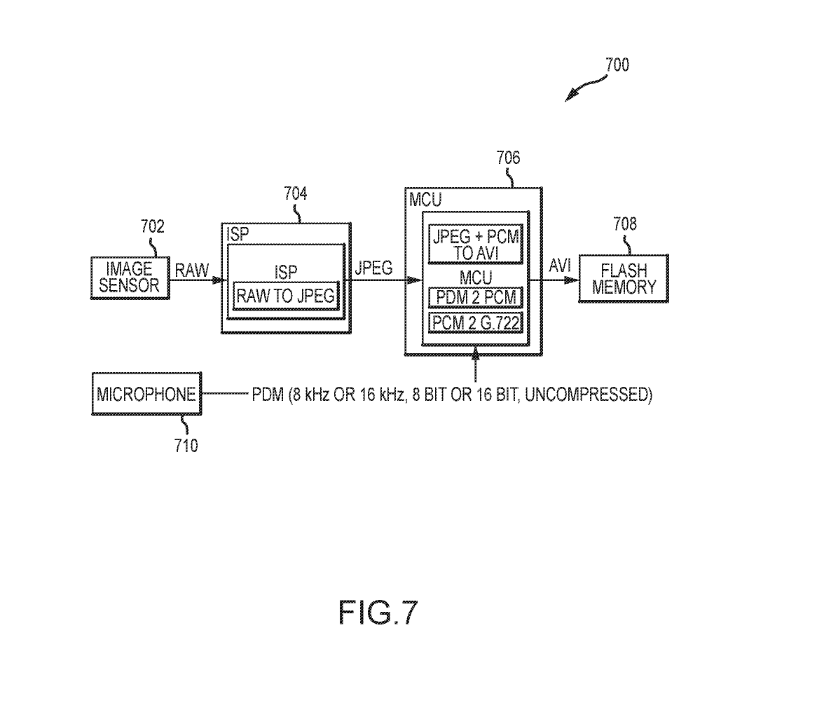

Examples of camera systems described herein may capture and process video files. FIG. 7 is a schematic illustration of a camera system arranged in accordance with examples described herein. The camera system 700 includes image sensor 702, image signal processor 704, microcontroller unit 706, flash memory 708, and microphone 710. The camera system 700 may be implemented by and/or may be used to implement any camera system described herein, such as camera system 100 of FIG. 1 and/or camera system 300 of FIG. 3.

The image sensor 702 may be used to capture raw image data of still images and/or a stream of images (e.g., video). The image sensor 702 may provide raw image data to the image signal processor 704. Signal to noise ratio (S/N) of the image sensor 702 may be 36 dB at 100 Lux (30-60 dB range) in some examples, and have a dynamic range of 60 dB (50-75 dB range) in some examples. The signal to noise ratio generally controls image quality while the dynamic ratio generally controls the image sensor's low light response. The image sensor 702. may have a selected set of functionalities directed at enhancement of image quality both in still pictures and videos, consistent with the requirements of dimensional and power constraints. For example, image processor 702 may include one or more of the following functionalities: 1. Integration time adjustment (exposure time) 2. Digital gain control, 3. White balancing 4. Lens distortion correction 5. Color reconstruction 6. Color calibration (KGB adjustment) 7. Gamma correction 8. Contrast stretch 9.Sharpness enhancement 10. Noise reduction 11. Image rotation 12. Image cropping 13. Pixel binning 13. Pixel defect correction and 14. Image/video compression.

Further options which may or may not be used and/or present in the example image sensor 702 include: 1. Object tracking 2. Digital zoom3. Image/video stabilization 4. Auto-focus 5. Flicker reduction for ambient light and 6. Colorspace conversion. This example selection is not meant to be limiting, but disclosed in order to illustrate the tradeoffs involved in selecting the most appropriate image processing options in order to comply with dimensional and power constraints:

The image signal processor 704 may process the raw image data, e.g., the image signal processor 704 may convert the raw image data to a video and/or image format, e.g., jpeg, by compressing the image to provide compressed image data. The microcontroller unit 706 may receive the compressed image data (e.g., jpeg data). The microcontroller unit 706 may additionally receive audio data captured, e.g., by microphone 710. For example, the microphone 710 may capture PDM at 8 kHz or 16 kHz, 8 bit or 16 bit, and the audio data may be uncompressed. The microcontroller unit 706 may receive the uncompressed audio data and may perform audio encoding (e.g., PCM). The microcontroller unit 706 may perform image encoding the compressed image data (e.g., m-j peg). The microcontroller unit 706 may package encoded images and encoded audio into one or more video containers (e.g., generate an avi file). The microcontroller unit 706 may store the avi output file in flash memory 708. Of course, other video file formats may be used such as, by way of example only, MPEG4, MOV, although other formats may require more processing power.

In this manner, examples of microcontroller units described herein may perform image encoding, audio encoding, and packaging (e.g., mixing) encoded image data and encoded audio data in a video container.

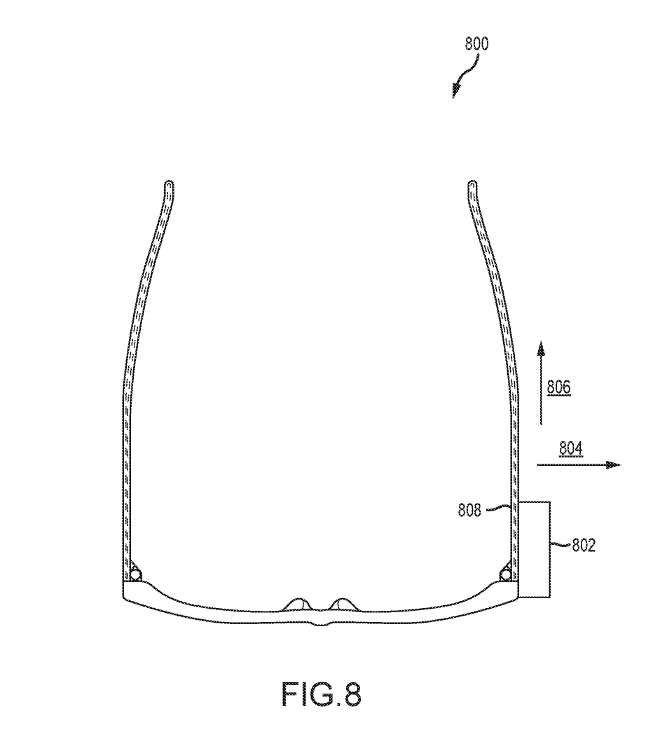

FIG. 8 is a schematic illustration of a camera system attached to eyewear arranged in accordance with examples described herein. The eyewear 800 includes temple 808. Camera system 802 is attached to temple 808. The camera system 802 is longer in a direction 806 parallel to the temple 808 than in either a perpendicular temple 808 or a perpendicular direction out of the page of FIG. 7. The camera system 802 may be implemented by and/or may be used to implement any camera system described herein, such as camera system 100 of FIG. 1 and/or camera system 300 of FIG. 3.

During use, camera systems described herein may be attached to eyewear. The eyewear 800 is shown, and may be implemented using prescription glasses, non-prescription glasses, sunglasses, binoculars, eyewear frames without lenses, goggles, etc. Camera system 802 may be attached to the eyewear 800. For example, the camera system 802 may be attached to a temple 808 of the eyewear 800. Attachment may be made in any manner, such as by securing the camera system 802 to temple 808 using one or more connectors (e.g., bands, adhesive). In some examples, the camera system 802 may be magnetically attached to temple 808. For example, the camera system 802 may include one or more magnets, which may be attracted to one or more ferromagnetic materials in the temple 808, or vice versa. In some examples, the temple 808 may include a track which may receive a portion of the camera system 802 having a magnet.

In some examples, a longer dimension of the camera system 802 may be parallel to the temple 808 during use. For example, a longer dimension of the camera system 802 (e.g., a length of the camera system 802) may be positioned along the temple, e.g. in direction 806. Recall a smallest dimension of various chips may have been selected to lie along perpendicular direction 804, such that a shorter dimension of the camera system 802 may be provided along direction 804. The chips themselves may be arranged along direction 804. In this manner, a convenient form factor and weight balance of a camera system may be provided for attachment to an eyewear temple.

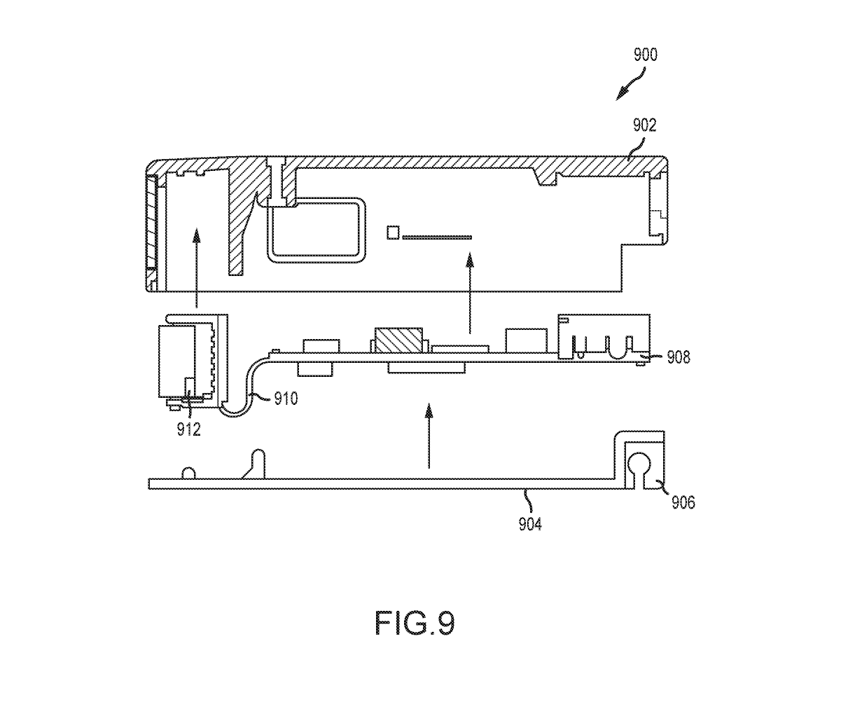

FIG. 9 is a schematic cutaway view of a camera system arranged in accordance with examples described herein. The camera system 900 may include upper housing 902, lower housing 904, securing feature 906, printed circuit board 908, flex connector 910, and camera module 912. Additional, fewer, and/or different components may be present in other examples. The camera system 900 may be used to implement and/or may be implemented by camera systems described herein, such as camera system 100 of FIG. 1, camera system 300 of FIG. 3, camera system 700 of FIG. 7, and/or camera system 802 of FIG. 8.

A housing for a camera system may be provided in multiple portions. For example, upper housing 902 and lower housing 904 may be provided in the example of FIG. 9. The portions of the housing may be fused, bonded, or otherwise connected together during assembly of the camera system.

One or more printed circuit boards, such as printed circuit board 908 of FIG. 9 may be coupled to an image sensor using a flex connector in examples described herein. For example, flex connector 910 may be used to electrically couple printed circuit board 908 to camera module 912. The camera module 912 may include an image sensor. The flex connector may allow for the printed circuit board to be arranged in a generally flat configuration extending perpendicularly away from an image sensor. The flex connector may implement a rotation to allow the planar printed circuit board to connect with the differently-oriented image sensor. The rotation may be a 90 degree rotation in some examples.

In some examples, a radius of curvature of the flex connector 910 may be over 3.0 mm for a flex connector which is 0.3 mm in thickness. Other thicknesses and/or radii of curvature may be used in other examples.

In some examples, a flex connector may not be used, and a PCB may be connected to an image sensor described herein using, for example, fixed connectors which may be placed at right angles (e.g., Molex 533091670). A bottom portion of the housing may at least partially define one or more features, such as securing feature 906. The securing feature 906 may include a recess defined by the lower housing 904. The recess may be used, during operation of the camera system, to hold a securing ring (e.g., a band, loop, etc), which may aid in retaining the camera system onto a wearable item (e.g., eyewear, eyewear temple, clothing, ring, necklace, watch) when a primary attachment mechanism (e.g., magnetic attachment, band attachment) inadvertently fails.

During assembly, the printed circuit board 908, flex connector 910, and camera module 912 may be positioned in upper housing 902 (e.g., by placing, pushing, and/or snapping). The lower housing 904 may then be secured to the upper housing 902 (e.g., by welding, snapping, and/or fusing).

Examples of camera systems described herein may include one or more visual output devices (e.g., a light) which may illuminate when the camera system is capturing images with the image sensor. The visual output may, for example, alert people present in the vicinity of the camera system that the camera system is actively capturing images and/or video. In some examples, to aid in visibility of the light, housings described herein may include a light pipe having a domed termination protruding from the housing. In other examples, housings described herein may include a light pipe terminating at a front surface of the camera housing.

From the foregoing it will be appreciated that, although specific embodiments have been described herein for purposes of illustration, various modifications may be made while remaining with the scope of the claimed technology.

1. A camera system comprising:
an image sensor configured to generate raw image data;
an image signal processor coupled to the image sensor and configured to compress the raw image data to provided compressed image data;
flash memory; and
a microcontroller unit coupled to the image signal processor and the flash memory, the microcontroller unit comprising firmware configured to receive the compressed image data and control the flash memory to store the compressed image data.

2. The camera system of claim 1, wherein the microcontroller unit is configured to provide write and read requests to the flash memory.

3. The camera system of claim 2, wherein the microcontroller unit is configured to implement direct memory access and includes internal RAM comprising at least one data buffer.

4. The camera system of claim 3, wherein the internal RAM comprises at least two alternating data buffers.

5. The camera system of claim 1, wherein the image signal processor and the microcontroller unit are provided on separate chips.

6. The camera system of claim 1, further comprising a Wi-Fi chip coupled to the microcontroller unit.

7. The camera system of claim 1, further comprising a housing enclosing the image signal processor and the microcontroller unit.

8. The camera system of claim 1, wherein the image signal processor, the microcontroller unit, and the flash memory are arranged along a first direction such that a first dimension of the camera system along the first direction is longer than a second dimension of the camera system, the second dimension being along a second direction perpendicular to the first direction.

9. The camera system of claim 8, wherein, during use, the camera system is attached to eyewear, and the first dimension of the camera system is parallel to a temple of the eyewear.

10. The camera system of claim 8, wherein the image signal processor and the microcontroller unit each measure less than 10 mm in the second direction.

11. The camera system of claim 1, wherein a volume of the camera system is less than 6,000 cubic millimeters.

12. The camera system of claim 1, wherein the camera system is devoid of a viewfinder.

13. A camera system comprising:
an image sensor configured to generate raw image data;
an image signal processor coupled to the image sensor and configured to receive the raw image data and process the raw image data into processed image data; and
a microcontroller unit coupled to the image signal processor and configured to receive the processed image data, the microcontroller unit comprising an internal memory and further configured to buffer the processed image data using the internal memory.

14. The camera system of claim 13, wherein the microcontroller unit is configured to buffer the processed image data without using external RAM.

15. The camera system of claim 13, wherein the microcontroller unit is configured to stream the data to flash memory external to the microcontroller unit.

16. The camera system of claim 15, wherein the flash memory is partitioned into a first area having a file system, and a second area without a file system, and wherein the microcontroller unit is configured to write the processed image data into the second area of the flash memory for fast streaming speed (“virtual RAM”) and later copy the processed image data into the first area at a lower speed.

17. The camera system of claim 16, wherein a circular buffer is implemented in the second area of the flash memory.

18. The camera system of claim 13, wherein the microcontroller unit comprises firmware configured to implement direct memory access.

19. The camera system of claim 13, wherein the internal memory comprises alternating data buffers.

20. The camera system of claim 13, further comprising a microphone configured to provide sound data, and wherein the microcontroller unit is coupled to the microphone and further configured to receive the sound data and package video files using the processed image data and the sound data.

21. The camera system of claim 20, wherein the microcontroller unit is configured to synchronize the processed image data with the sound data.

22. The camera system of claim 20, wherein the image signal processor and the microcontroller unit are provided on separate chips.

23. A camera system comprising:
an image signal processor;
a processing unit coupled to the image signal processor;
an external non-volatile memory, wherein the processing unit is configured to use the external non-volatile memory as random access memory when processing image data provided by the image signal processor, and wherein the processing unit is configured to preserve most of the external non-volatile memory for image file storage, wherein the image file storage is accessible by an external device.

24. The camera system of claim 23 wherein the image file storage is accessible by the external device using a wireless connection via WIFI or Bluetooth.

25. The camera system of claim 23 wherein said external device is configured to access the image file storage through a physical connection.

26. The camera system of claim 25, wherein the physical connection comprises a USB connection.
